(19) United States
(12) Patent Application Publication
(10) Pub. No.: US 2025/0304502 A1
(43) Pub. Date: Oct. 2, 2025

(54) DIELECTRIC CERAMIC COMPOSITION AND MULTILAYER CERAMIC ELECTRONIC DEVICE

(71) Applicant: TDK Corporation, Tokyo (JP)

(72) Inventors: Yutaka SUWAZONO, Tokyo (JP); Nobuto MORIGASAKI, Tokyo (JP); Taku MURAKAMI, Tokyo (JP); Toshihiro IGUCHI, Tokyo (JP); Ayako SATO, Tokyo (JP); Yasuhiro ITO, Tokyo (JP)

(73) Assignee: TDK Corporation, Tokyo (JP)

(21) Appl. No.: 19/083,677

(22) Filed: Mar. 19, 2025

(30) Foreign Application Priority Data
Mar. 27, 2024 (JP) 2024-052281

(51) Int. Cl. C04B 35/49; H01G 4/12; H01G 4/30

(52) U.S. Cl. CPC C04B 35/49; H01G 4/1227; C04B 2235/3217; C04B 2235/3241; C04B 2235/3249; C04B 2235/3262; C04B 2235/3418; C04B 2235/768; C04B 2235/785; C04B 2235/786; C04B 2235/85; H01G 4/30

(57) ABSTRACT

A dielectric ceramic composition includes main phase grains and a grain boundary. The main phase grains include a perovskite compound as a main component. The perovskite compound includes at least Ca, Sr, Zr, and Ti. The dielectric ceramic composition further includes an oxide of at least one additional element. The dielectric ceramic composition has a total content of Ti, Mn, and Cr of 7.0 parts by mol or less. The main phase grains include a specific main phase grain. The specific main phase grain includes a first minute region having a high total content of Mn and Cr and a second minute region having a low total content of Mn and Cr. The first minute region is located in a peripheral portion of the specific main phase grain. The second minute region is located in a central portion of the specific main phase grain.

### TECHNICAL FIELD

The present invention relates to a dielectric ceramic composition and a multilayer ceramic electronic device.

### BACKGROUND

Patent Document 1 discloses an invention related to a nonreducible dielectric ceramic composition and a multilayer ceramic capacitor including ceramic sheets composed of the nonreducible dielectric ceramic composition and electrodes alternately laminated.
Patent Document 1: JP Patent Application Laid Open No. 2007-91588

### SUMMARY

The present invention is directed to a dielectric ceramic composition that enables a multilayer ceramic electronic device with good temperature characteristics and excellent insulation characteristics to be provided.

In response to the above, a dielectric ceramic composition according to the present invention is
a dielectric ceramic composition including:
main phase grains; and
a grain boundary between the main phase grains,
wherein
the main phase grains include a perovskite compound as a main component;
the perovskite compound includes at least Ca and Sr as A-site elements and at least Zr and Ti as B-site elements;
the dielectric ceramic composition further includes an oxide of at least one additional element;
the at least one additional element includes at least one selected from the group consisting of Mn and Cr;
the dielectric ceramic composition has a total content of Ti, Mn, and Cr of 7.0 parts by mol or less with respect to 100 parts by mol B-site elements;
the main phase grains include a specific main phase grain;
the specific main phase grain includes a first minute region and a second minute region;
the first minute region has an atomic ratio of a total content of Mn and Cr to a total content of Ti, Mn, and Cr of 0.2 or more;
the second minute region has an atomic ratio of a total content of Mn and Cr to a total content of Ti, Mn, and Cr of less than 0.2;
the first minute region is located in a peripheral portion of the specific main phase grain and has a thickness of a quarter or more of an equivalent circle radius of the specific main phase grain from the grain boundary to a center of the specific main phase grain; and the second minute region is located in a central portion of the specific main phase grain.

A number ratio of the specific main phase grain to the main phase grains may be 30% or more and 90% or less.

The first minute region may account for an area ratio of 50% or more and 95% or less of a section of the dielectric ceramic composition.

The at least one additional element may include Si, Al, and at least one selected from the group consisting of Mn and Cr;
the dielectric ceramic composition may have a total content of the at least one additional element of 1.8 parts by mol or more and 5.0 parts by mol or less with respect to 100 parts by mol B-site elements;
the dielectric ceramic composition may have a total content of Mn and Cr exceeding a Si content of the dielectric ceramic composition; and
the grain boundary may have a Si content exceeding a total content of Mn and Cr of the grain boundary.

The main phase grains may have an average grain size of 0.50 um or more and 1.20 um or less.

A multilayer ceramic electronic device according to the present invention includes the dielectric ceramic composition described above.

### BRIEF DESCRIPTION OF THE DRAWING(S)

FIG. 1 is a schematic sectional view of a multilayer ceramic capacitor according to one embodiment of the present invention.

FIG. 2 is a HAADF image of a dielectric ceramic composition according to the embodiment of the present invention.

FIG. 3 is a Mn mapping image of a measurement range same as that of FIG. 2.

FIG. 4 is a HAADF image of the dielectric ceramic composition according to the embodiment of the present invention.

FIG. 5 is a graph showing results of a line analysis.

FIG. 6 is a graph showing results of the line analysis.

### DETAILED DESCRIPTION

Hereinafter, the present invention is described with reference to a specific embodiment.

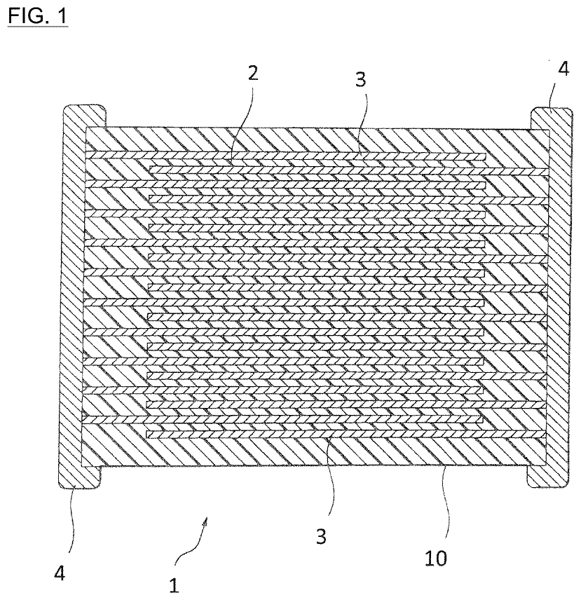

FIG. 1 shows a multilayer ceramic capacitor 1 as an example electronic device according to the present embodiment. The multilayer ceramic capacitor 1 includes an element body 10, in which dielectric layers 2 and internal electrode layers 3 are alternately laminated. At both ends of the element body 10, a pair of external electrodes 4 is provided. The external electrodes 4 are electrically connected to the internal electrode layers 3 alternately arranged inside the element body 10. The element body 10 may have any shape but normally has a rectangular parallelepiped shape. The element body 10 may have any dimensions. The dimensions are appropriately determined according to uses.

The dielectric layers 2 are composed of a dielectric ceramic composition according to the present embodiment described later. The dielectric layers 2 may have any thickness (interlayer thickness) per layer. The interlayer thickness can be freely determined according to desired characteristics, uses, etc. Normally, the interlayer thickness is preferably 100 um or less or is more preferably 30 um or less. The number of the dielectric layers 2 is not limited. In the present embodiment, the number of the dielectric layers 2 is preferably, for example, twenty or more.

The internal electrode layers 3 are laminated so that their end surfaces are alternately exposed to surfaces of two ends of the element body 10 facing each other.

The internal electrode layers 3 contain a conductive material having a main component composed of metal. The metal is not limited and is, for example, a conductive material known as metal (e.g., Pd, a Pd based alloy, Pt, a Pt based alloy, Ni, a Ni based alloy, Cu, and a Cu based alloy). The metal may contain about 0.1 mass % or less each of various trace components, such as P, S, and Cl. To form the internal electrode layers 3, a commercially available electrode paste may be used. The thickness of the internal electrode layers 3 is appropriately determined according to uses or the like.

The external electrodes 4 may contain any conductive material. For example, a known conductive material (e.g., Ni, Cu, Sn, Ag, Pd, Pt, Au, their alloys, and a conductive resin) is used. The thickness of the external electrodes 4 is appropriately determined according to uses or the like.

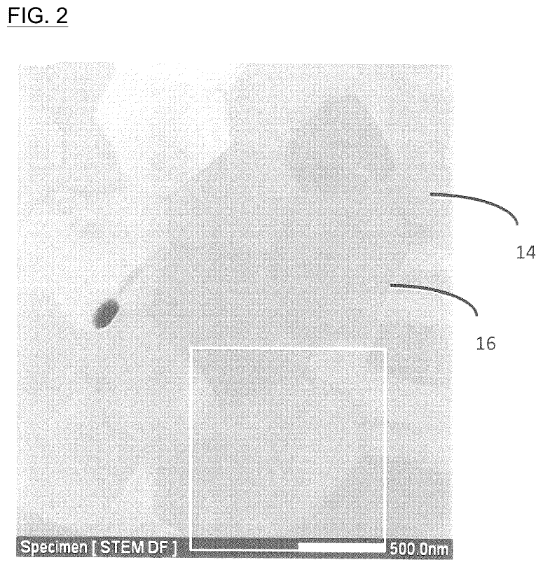

Any method of observing the structure of the dielectric ceramic composition may be used. For example, a backscattered electron image or a HAADF image of a section of the dielectric ceramic composition is observed. The backscattered electron image can be obtained using, for example, a scanning electron microscope (SEM). The HAADF image can be obtained using, for example, a scanning transmission electron microscope (STEM). FIG. 2 is a HAADF image of a section of the dielectric ceramic composition. FIG. 2 is a HAADF image of Example 1 described later. Note that, in the following description, a HAADF image observed using a STEM may simply be referred to as a STEM image.

As shown in FIG. 2, the dielectric ceramic composition according to the present embodiment includes main phase grains 14 and a grain boundary 16 between the main phase grains 14. The main phase grains 14 are often identifiable as light-contrast portions compared to the grain boundary 16 in a backscattered electron image and a HAADF image. This is because the main phase grains 14 are often denser than the grain boundary 16. Thus, the grain boundary 16, which is often less dense than the main phase grains 14, is often identifiable as a dark-contrast portion.

A field of view for shooting may have any size. The field of view has, for example, a dimension of about 1 to 50 um on all four sides and an area of about 1 to 2500 um². The size of the field of view for shooting is appropriately selected according to purpose.

The main phase grains 14 contain a perovskite compound as a main component. A perovskite compound is a compound having a perovskite-type crystal structure represented by a formula ABO₃ (where A includes A-site elements and B includes B-site elements).

The perovskite compound contains at least Ca and Sr as A-site elements and at least Zr and Ti as B-site elements. The perovskite compound may further contain Ba as an A-site element and Hf as a B-site element.

In a situation where only Sr is contained and Ca is not contained as an A-site element, temperature characteristics and insulation characteristics are reduced. In a situation where only Ca is contained and Sr is not contained as an A-site element, insulation characteristics are reduced. In a situation where neither Ca nor Sr is contained as an A-site element, temperature characteristics are reduced, and insulation characteristics are significantly reduced.

In a situation where only Zr is contained and Ti is not contained as a B-site element, temperature characteristics are reduced. In a situation where only Ti is contained and Zr is not contained as a B-site element, temperature characteristics are significantly reduced. In a situation where neither Zr nor Ti is contained as a B-site element, temperature characteristics and insulation characteristics are reduced.

Out of 100 parts by mol A-site elements, the Ca content may be 30 parts by mol or more and 90 parts by mol or less or may be 50 parts by mol or more and 80 parts by mol or less. Out of 100 parts by mol A-site elements, the Sr content may be 10 parts by mol or more and 50 parts by mol or less or may be 20 parts by mol or more and 45 parts by mol or less. Out of 100 parts by mol A-site elements, the Ba content may be 0 parts by mol or more and 20 parts by mol or less or may be 0 parts by mol or more and 5.0 parts by mol or less.

Out of 100 parts by mol B-site elements, the Zr content may be 90 parts by mol or more and 99 parts by mol or less or may be 94 parts by mol or more and 98 parts by mol or less. Out of 100 parts by mol B-site elements, the Ti content may be 0.5 parts by mol or more and less than 7.0 parts by mol or may be 2.0 parts by mol or more and 6.0 parts by mol or less. Out of 100 parts by mol B-site elements, the Hf content may be 0 parts by mol or more and 2.0 parts by mol or less.

The dielectric ceramic composition according to the present embodiment further contains, other than the above perovskite compound, an oxide of an additional element or oxides of additional elements. The additional element or elements may be of any kind.

As the additional element, at least one selected from Mn and Cr is contained. In a situation where neither Mn nor Cr is contained, the main phase grains 14 cannot include a first minute region described later.

With respect to 100 parts by mol B-site elements, the total content of Ti, Mn, and Cr of the dielectric ceramic composition is 7.0 parts by mol or less. In a situation where the total content of Ti, Mn, and Cr is too high, it is difficult to provide the microstructure of the dielectric ceramic composition according to the present embodiment including specific main phase grains described later at a specific number ratio. Moreover, the higher the total content of Ti, Mn, and Cr, which are elements whose valences readily change, the more readily insulation resistance tends to be reduced. In particular, in a situation where the total content of Mn and Cr is too high, it is difficult to provide the specific main phase grains described later because Mn and/or Cr solid-dissolves in the main phase grains 14 too much.

As the additional elements, Si, Al, and at least one selected from Mn and Cr may be contained. Moreover, as the additional elements, elements other than Mn, Cr, Si, and Al (e.g., Mg, Li, B, and/or V) may be contained.

With respect to 100 parts by mol B-site elements, the total content of the additional elements of the dielectric ceramic composition may be 1.8 parts by mol or more and 5.0 parts by mol or less. Moreover, it may be that the total content of Mn and Cr of the dielectric ceramic composition exceeds the Si content of the dielectric ceramic composition and that the Si content of the grain boundary 16 exceeds the total content of Mn and Cr of the grain boundary 16. Specifically, a value obtained by subtracting the Si content of the dielectric ceramic composition with respect to 100 parts by mol B-site elements from the total content of Mn and Cr of the dielectric ceramic composition with respect to 100 parts by mol B-site elements may be 0.1 parts by mol or more. Moreover, a value obtained by subtracting the total content of Mn and Cr of the grain boundary 16 with respect to 100 parts by mol B-site elements from the Si content of the grain boundary 16 with respect to 100 parts by mol B-site elements may be 0.1 parts by mol or more.

In a situation where a is less than 1.8 parts by mol, where a denotes the total content of the additional elements with respect to 100 parts by mol B-site elements, the dielectric is less readily sintered, which readily reduces insulation characteristics. In a situation where a exceeds 5.0 parts by mol, compounds containing the A-site elements and the additional elements are readily segregated, which readily reduces insulation characteristics.

In a situation where the total content of Mn and Cr of the dielectric ceramic composition is not more than the Si content thereof, less Mn and/or less Cr readily solid-dissolves in the main phase grains 14 and, moreover, the dielectric is less readily sintered. Thus, insulation characteristics are readily reduced.

In a situation where the Si content of the grain boundary 16 is not more than the total content of Mn and Cr thereof, insulation characteristics are readily reduced because the electrical resistance of the grain boundary 16 is readily reduced.

The main phase grains 14 may have any average grain size. The average grain size may be, for example, 0.20 um or more and 1.40 um or less, or 0.50 um or more and 1.20 um or less. In particular, in a situation where the main phase grains 14 have an average grain size of 0.50 um or more and 1.20 um or less, insulation characteristics are readily improved.

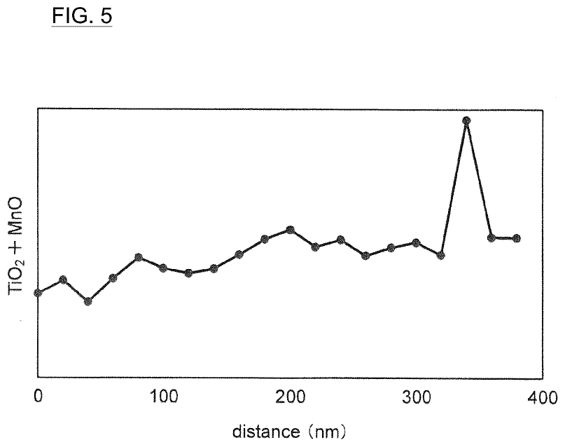

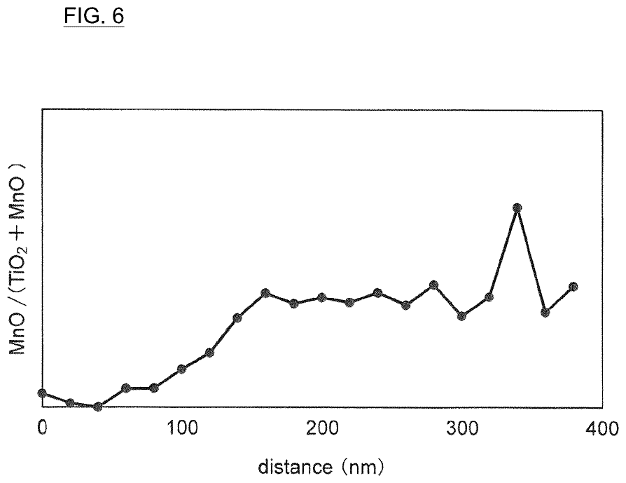

99 wt % or more of the above A-site elements, B-site elements, and additional elements of the dielectric ceramic composition is contained as simple oxides or complex oxides. FIGS. 5 to 6 described later show changes in the content of simple oxides of the elements. Changes in the content of such elements are actually converted into the changes in the content of the simple oxides. In the dielectric ceramic composition, the elements are contained in a form of a simple oxide, a complex oxide, or the like.

At least some of the main phase grains 14 included in the dielectric ceramic composition according to the present embodiment are the specific main phase grains. A specific main phase grain is a main phase grain 14 that includes a first minute region, which is in a peripheral portion of the main phase grain 14 and has a thickness of 100 nm or more from the grain boundary 16 towards a center of the main phase grain 14, and a second minute region, which is located in a central portion of the main phase grain 14.

The first minute region is a region having an atomic ratio of the total content of Mn and Cr to the total content of Ti, Mn, and Cr of 0.2 or more. The second minute region is a region having an atomic ratio of the total content of Mn and Cr to the total content of Ti, Mn, and Cr of less than 0.2. The main phase grains other than the specific main phase grains as well include the first minute region and/or the second minute region.

In a section of the dielectric ceramic composition, the peripheral portion of the main phase grain 14 is where the distance from a boundary between the main phase grain 14 and the grain boundary 16 into the main phase grain 14 is 10 nm or less. The center of the main phase grain 14 means a center of gravity of the main phase grain 14 in the section. The central portion of the main phase grain 14 is where the distance from the center of the main phase grain 14 is not more than half the equivalent circle radius of the main phase grain 14. The equivalent circle radius is the radius of a circle having the same area as that of the main phase grain 14. The equivalent circle radius is half the length of the equivalent circle diameter.

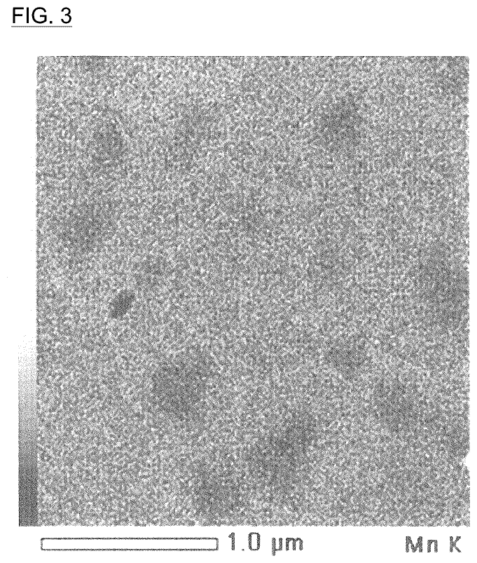

The dielectric ceramic composition shown in FIG. 2 contains Mn but does not contain Cr. FIG. 3 is a Mn mapping image, created with STEM-EDS, of the same range as that of FIG. 2. In FIG. 3, a portion with a higher Mn concentration looks lighter.

According to a comparison between FIGS. 2 and 3, some of the main phase grains 14 shown in FIG. 2 have a portion (the second minute region) with a low Mn concentration in the central portion and its vicinity and a portion (the first minute region) with a high Mn concentration in the peripheral portion and its vicinity. That is, it can be confirmed that some of the main phase grains 14 are the specific main phase grains.

The number ratio of the specific main phase grains to the main phase grains 14 included in the dielectric ceramic composition may be 30% or more and 90% or less. When the number ratio is calculated, first, at least two fields of view each having an area of 6.0 um² or more are observed in a section of the dielectric ceramic composition. The number of the main phase grains 14 included in their entirety in the fields of view is calculated. Further, the number of the specific main phase grains among the main phase grains 14 included in their entirety in the fields of view is calculated. Then, the number ratio is calculated.

In a situation where the number ratio of the specific main phase grains is less than 30%, insulation resistance is readily reduced because the main phase grains 14 readily have fewer portions in which Mn and/or Cr is solid-dissolved. In a situation where the number ratio of the specific main phase grains exceeds 90%, the percentage of the B-site elements of the perovskite compound replaced with Mn increases, by which the balance between the A-site elements and the B-site elements is readily lost. Consequently, insulation resistance is readily reduced.

The first minute region may account for an area ratio of 50% or more and 95% or less of a section of the dielectric ceramic composition. When the area ratio of the first minute region is calculated, first, at least two fields of view each having an area of 6.0 um² or more are observed in the section of the dielectric ceramic composition. The area of the first minute region of the main phase grains 14 in each field of view is divided by the area of the field of view.

In a situation where the area ratio of the first minute region is less than 50%, insulation resistance is readily reduced because the main phase grains 14 readily have fewer portions in which Mn and/or Cr is solid-dissolved. In a situation where the area ratio of the first minute region exceeds 95%, the percentage of the B-site elements of the perovskite compound replaced with Mn increases, by which the balance between the A-site elements and the B-site elements is readily lost. Consequently, insulation resistance is readily reduced.

Changes in the content of each element of the main phase grains 14 and the grain boundary 16 are described below with a specific example.

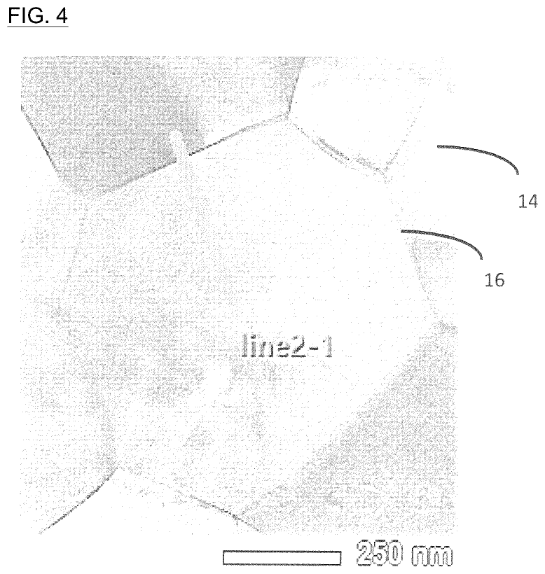

FIG. 4 is a STEM image in which a portion of FIG. 2 boxed in a rectangle is enlarged. While a part of the portion boxed in the rectangle is not shown in FIG. 2, FIG. 4 shows the portion including that part. FIGS. 5 and 6 show results of a line analysis along a line denoted by line 2-1 in FIG. 4 from its lower end to its upper end using STEM-EDS. Note that, while the dielectric ceramic composition, whose various measurement results are shown in FIGS. 2 to 6, contains Mn but does not contain Cr, even if Mn of the dielectric ceramic composition is replaced with Cr, there is a similar tendency.

According to FIG. 5, in the main phase grain 14, the total content of Ti and Mn tends to slightly increase as the distance from the grain boundary 16 decreases. At the grain boundary 16, the total content of Ti and Mn significantly increases.

According to FIG. 6, near the center of the main phase grain 14, the ratio of the Mn content to the total content of Ti and Mn is small. This implies that such a portion where the ratio of the Mn content to the total content of Ti and Mn is small is the second minute region. In a range of 100 nm or more from the vicinity of the grain boundary 16, the ratio of the Mn content to the total content of Ti and Mn is large. This implies that such a portion where the ratio of the Mn content to the total content of Ti and Mn is large is the first minute region.

Hereinafter, an example method of manufacturing the multilayer ceramic capacitor 1 shown in FIG. 1 is described.

First, steps of manufacturing the element body 10 are described. In the steps of manufacturing the element body 10, a dielectric paste to be the dielectric layers 2 after firing and an internal electrode paste to be the internal electrode layers 3 after firing are prepared.

Any method of manufacturing the dielectric paste may be used. The dielectric paste is manufactured using, for example, the following method. First, a raw material powder that mainly becomes the dielectric ceramic composition of the main phase grains 14 is prepared. As the raw material powder, a commercially available perovskite compound powder may be prepared. Alternatively, powders of oxides of the A-site elements of the perovskite compound and powders of oxides of the B-site elements thereof may be prepared, dispersed in a solvent (e.g., purified water), dried, and subject to a heat treatment to give the raw material powder. The heat treatment for providing the raw material powder may be carried out at any holding temperature. The holding temperature may be, for example, 900° C. or more and 1300° C. or less. The holding time is not limited. The holding time may be, for example, 0.5 hours or more and 5 hours or less.

Together with the powders of the oxides of the A-site elements and the powders of the oxides of the B-site elements of the perovskite compound, powders of oxides of the additional elements may be dispersed in the solvent at the same time.

Instead of the powders of the oxides of the above elements, powders of compounds that become the oxides of the elements by sintering (e.g., powders of carbonates of the elements) may be used. Alternatively, powders of complex compounds of the elements may be used.

The raw material powder may have any specific surface area at this time. The specific surface area measured using the BET adsorption method may be 3.0 m²/g or more and 20 m²/g or less. The larger the specific surface area of the raw material powder, the larger the average grain size of the main phase grains 14 of the dielectric ceramic composition eventually obtained tends to be.

Then, the raw material powder and the powders of the oxides of the additional elements (powders of compounds that become the oxides of the elements by sintering may be used) may be dispersed in a solvent (e.g., purified water), dried, and subject to a heat treatment to give a dielectric powder. The holding temperature of the heat treatment is not limited. The holding temperature may be, for example, 300° C. or more and 700° C. or less. The holding time is not limited. The holding time may be, for example, 0.5 hours or more and 5 hours or less. The higher the holding temperature and the longer the holding time of the heat treatment for preparing the dielectric powder, the more readily Mn and/or Cr solid-dissolves in the main phase grains 14 in their entirety. Thus, the main phase grains 14 each including the first minute region but not including the second minute region increase. This reduces temperature characteristics of the dielectric ceramic composition.

The resultant dielectric powder, a binder, and a solvent (an organic solvent or water) are kneaded to give the dielectric paste. The binder and the solvent may be of any type. Instead of the binder and the solvent, an organic vehicle in which a binder and an organic solvent are mixed may be used. The dielectric paste may include additives, such as plasticizers and dispersants, as necessary.

The internal electrode paste is prepared by kneading a raw material of the above-mentioned conductive material, a binder, and a solvent (an organic solvent or water). The binder and the solvent may be of any type. The internal electrode paste may include additives, such as inhibitors and plasticizers, as necessary.

Using the resultant pastes, green sheets and internal electrode patterns are formed; and they are laminated to give a green chip.

The resultant green chip may be subject to a binder removal treatment as necessary. Conditions of the binder removal treatment are known conditions. The holding temperature may be, for example, 180° C. or more and 400° C. or less. The holding time may be, for example, 0.5 hours or more and 24 hours or less. The binder removal atmosphere is also not limited. In a reducing atmosphere, the holding temperature may be 1100° C. or less.

After the binder removal treatment, the green chip is fired to give the element body 10. In the present embodiment, the firing atmosphere may be a reducing atmosphere with an oxygen partial pressure of 2.0×10⁻¹³ atm or more and 1.0×10⁻⁷ atm or less. Other firing conditions are known conditions. The holding temperature may be, for example, 1200° C. or more and 1400° C. or less. The holding time may be, for example, 0.5 hours or more and 8 hours or less.

After firing, an annealing treatment may be carried out as necessary. Conditions of the annealing treatment are not limited. The holding temperature may be, for example, 500° C. or more and 1150° C. or less. The holding time may be, for example, 0.5 hours or more and 20 hours or less. The oxygen partial pressure of the annealing atmosphere is, for example, 1.0×10⁻⁹ atm or more and 3.0×10⁻⁵ atm or less.

The dielectric ceramic composition constituting the dielectric layers 2 of the resultant element body 10 given as above is the dielectric ceramic composition described above. End surfaces of this element body 10 are polished as necessary. To these end surfaces, an external electrode paste is applied. The applied paste is baked to form the external electrodes 4. On surfaces of the external electrodes 4, a coating layer is formed by plating or the like as necessary. Any method of preparing the external electrode paste may be used. The external electrode paste may be prepared using a method similar to the method of preparing the internal electrode paste.

In this manner, the multilayer ceramic capacitor 1 according to the present embodiment is manufactured.

Although one embodiment of the present invention has been described above, the present invention is not limited to the above embodiment and can be variously modified without departing from the gist of the present invention.

### EXAMPLES

Hereinafter, the present invention is described based on more detailed examples; however, the present invention is not limited to these examples.

### Experiment 1

In Experiment 1, multilayer ceramic capacitors 1 shown in FIG. 1 were manufactured using the following procedure.

First, a dielectric paste was prepared. A raw material powder (which may hereinafter be referred to as a “main-component raw material powder”) of a perovskite compound contained as a main component of main phase grains was produced. Specifically, a raw material powder of a Ca oxide, a raw material powder of a Sr oxide, a raw material powder of a Ba oxide, a raw material powder of a Zr oxide, and a raw material powder of a Ti oxide were prepared and weighed so as to provide the perovskite compound shown in Table 1. Note that “a raw material powder of a γ oxide” denoted a powder of the γ oxide and/or a powder of a compound that became the powder of the γ oxide by a heat treatment. Then, the powders were dispersed in purified water, were dried, and were further subject to a heat treatment (holding temperature: 1150° C. to 1250° C., holding time: 0.5 to 5 hours) to give the main-component raw material powder having a specific surface area of about 3.5 to 20 m²/g measured using the BET adsorption method. In Example 6, the main-component raw material powder had a specific surface area of about 20 m²/g. In Examples and Comparative Examples of Experiment 1 other than Examples 6 and 7, the main-component raw material powder had a specific surface area of about 5.0 m²/g. Example 7 is described later.

Separately, powders of oxides of additional elements (a raw material powder of a Mn oxide, a raw material powder of a Cr oxide, a SiO₂ powder, and/or an Al₂O₃ powder) were prepared and weighed so that the oxides of the elements were contained in amounts shown in Table 1 in a dielectric ceramic composition. At this time, the powders were weighed so that the additional elements were contained in descending order of content shown in Table 1 in terms of atomicity.

The main-component raw material powder and the powders of the oxides of the additional elements were dispersed in purified water, were dried, and were further subject to a heat treatment to give a dielectric powder. Except for Comparative Example 6, the holding temperature was 400° C. In Comparative Example 6, the holding temperature was 1200° C. The holding time was 2.0 hours.

The dielectric powder and an organic vehicle were kneaded to give the dielectric paste. With 100 parts by mass dielectric powder, 10 parts by mass polyvinyl butyral resin, 5 parts by mass dioctyl phthalate (DOP) as a plasticizer, and 100 parts by mass alcohol as a solvent were mixed using a ball mill; and the mixture was turned into a paste to give the dielectric paste.

In Example 7, a main-component raw material powder having a specific surface area of about 20 m²/g and a main-component raw material powder having a specific surface area of about 3.5 m²/g were prepared at a weight ratio of 50:50. These two types of main-component raw material powders having the same composition and different specific surface areas, the powders of the oxides of the additional elements, and an organic vehicle were kneaded to give the dielectric paste.

A method of preparing an internal electrode paste was as follows. First, a Ni powder, terpineol, ethyl cellulose, and benzotriazole were prepared at a mass ratio of 44.6:52.0:3.0:0.4. They were kneaded using a triple-roll mill and were turned into a paste to give the internal electrode paste.

Then, using the dielectric paste and the internal electrode paste, green chips were manufactured with a sheet method. The green chips were then subject to a binder removal treatment, a firing treatment, and an annealing treatment to give element bodies 10 having a rectangular parallelepiped shape measuring 3.2 mm×1.6 mm×0.7 mm. 3.2 mm was the horizontal dimension in FIG. 1. 0.7 mm was the vertical dimension (in the lamination direction) in FIG. 1. The holding temperature of the firing treatment was 1200° C. to 1300° C. The holding time of the firing treatment was 2.0 hours. The firing atmosphere was a reducing atmosphere with an oxygen partial pressure of 2.0×10⁻¹³ atm or more and 1.0×10⁻⁷ atm or less. In each of the resultant element bodies 10, the number of dielectric layers 2 interposed between internal electrode layers 3 was ten; the dielectric layers 2 interposed between the internal electrode layers 3 had an average thickness of 5.0 um; and the internal electrode layers 3 had an average thickness of 1.2 um.

With regard to the holding temperature during firing, each sample was subject to preliminary testing at six holding temperatures, i.e., 1200° C., 1220° C., 1240° C., 1260° C., 1280° C., and 1300° C. The lowest holding temperature among the holding temperatures at which the element body 10 densified was adopted. Whether the element body 10 densified or not was checked by observing a section of the element body 10 using a SEM. Specifically, in the section of the element body 10, whether the area of pores in a field of view measuring 450 um² or more was 2% or less of the area of the dielectric layers 2 in the field of view was checked. In a situation where the element body 10 did not densify at any of the holding temperatures, the holding temperature at which the degree of densification of the element body 10 was the highest was adopted. That is, the holding temperature was 1300° C.

Then, on outer surfaces of the above element bodies 10, a baked electrode layer containing Cu, a Ni plating layer, and a Sn plating layer were formed in the order mentioned to form external electrodes 4. Thus, the multilayer ceramic capacitors 1 were obtained.

### (Composition of Dielectric Ceramic Composition)

With regard to the composition of the dielectric ceramic composition, a composition analysis of the dielectric layers 2 was carried out using ICP optical emission spectroscopy. It was confirmed that the prepared composition and the composition of the dielectric ceramic composition had substantially the same A-site elements content, substantially the same B-site elements content, and substantially the same additional elements content. Also confirmed was a comparison between the total content of Mn and Cr of the dielectric ceramic composition and the Si content of the dielectric ceramic composition in terms of atomicity. Table 1 shows the results.

### (Comparison Between Additional Elements in Grain Boundary 16)

The total content of Mn and Cr of the grain boundary 16 and the Si content of the grain boundary 16 in terms of atomicity were compared in an element analysis using STEM-EDS. Specifically, five measurement locations were determined as in FIG. 4, and a line analysis was carried out there. Each additional element content in terms of atomicity at these locations included in the grain boundary 16 was averaged. Table 1 shows the results.

(Presence or Absence of Specific Main Phase Grains and their Number Ratio)

The presence or absence of specific main phase grains and the number ratio of the specific main phase grains were checked using STEM-EDS. Specifically, multiple fields of view measuring 20 um² in total were determined and observed. Whether at least ten main phase grains 14 included in their entirety in the fields of view were the specific main phase grains or not was checked. Table 1 shows the results.

### (Average Grain Size of Main Phase Grains 14)

The average grain size of the main phase grains 14 was measured by observing a section of the dielectric layers 2 using a SEM. Specifically, a field of view including at least fifty main phase grains 14 in their entirety was determined; equivalent circle diameters of these main phase grains 14 were calculated; and the measurement was averaged. Note that an equivalent circle diameter of a main phase grain 14 was a diameter of a circle having the same area as that of the main phase grain 14. Table 1 shows the results.

### (Area Ratio of First Minute Regions of Main Phase Grains 14)

The area ratio of first minute regions of the main phase grains 14 was measured by observing a section of the dielectric layers 2 using STEM-EDS. Specifically, multiple fields of view measuring 20 um² in total were determined and observed. In each field of view, the area ratio of a portion whose ratio of the total content of Mn and Cr to the total content of Ti, Mn, and Cr was 0.2 or more was calculated. Table 1 shows the results. Note that, in Comparative Example 3, no portion whose ratio of the total content of Mn and Cr to the total content of Ti, Mn, and Cr was 0.2 or more was confirmed.

### (Temperature Characteristics)

The capacitance temperature coefficient τC (unit: ppm/° C.) was measured to evaluate temperature characteristics of the multilayer ceramic capacitors 1. Specifically, at 25° C. and at 125° C., a signal with a frequency of 1 kHz and an input signal level (measurement voltage) of 1 Vrms was input to the multilayer ceramic capacitors to measure the capacitance at each temperature. Using capacitance C25 at 25° C. and capacitance C125 at 125° C., τC was calculated with the following formula.

$$τ C = \{ ( C 125 - C 25 ) / C 25 \} \times \{ 1 / ( 125 - 25 ) \}$$

Ten multilayer ceramic capacitors 1 were subject to measurement of their τC, and their average was calculated. When the average τC was −30 ppm/° C. or more and +30 ppm/° C. or less, the temperature characteristics column of Table 1 was marked with “Passed”. When the average τC was less than −30 ppm/° C. or above +30 ppm/° C., the temperature characteristics column of Table 1 was marked with “Failed”.

### (Hot-IR Test)

Insulation resistance of the multilayer ceramic capacitors 1 in a strong electric field at a high temperature was evaluated. Specifically, their insulation resistance at 200° C. under application of a direct voltage of 500 V (100 V/um) was measured. Table 1 shows the results. A hot-IR of 1.0×10¹²Ω or more was deemed good. A hot-IR of 3.0×10¹²Ω or more was deemed better. In Table 1, “βE+γ” means “β×10^{γ}”.

TABLE 1

| | | | Dielectric | | | | |
|---|---|---|---|---|---|---|---|
| | | | | | Additional | | |
| | | | | | element in | | |
| | | | α | Ti + Mn + Cr | descending | Mn + Cr − Si | |
| | Perovskite compound | | [parts | [parts | order of | | Grain |
| Sample No. | A site | B site | by mol] | by mol] | content | Dielectric | boundary |
| Example 1 | Ca_{0.70}Sr_{0.30} | Zr_{0.96}Ti_{0.04} | 4.0 | 6.0 | Mn, Si, Al | >0 | <0 |
| Example 2 | Ca_{0.70}Sr_{0.30} | Zr_{0.96}Ti_{0.04} | 4.0 | 6.0 | Cr, Si, Al | >0 | <0 |
| Example 3 | Ca_{0.60}Sr_{0.35}Ba_{0.05} | Zr_{0.96}Ti_{0.04} | 4.0 | 6.0 | Mn, Si, Al | >0 | <0 |
| Example 4 | Ca_{0.50}Sr_{0.45}Ba_{0.05} | Zr_{0.95}Ti_{0.05} | 3.6 | 6.8 | Mn, Si, Al | >0 | <0 |
| Comparative Example 1 | Sr | Zr_{0.96}Ti_{0.04} | 4.0 | 6.0 | Mn, Si, Al | >0 | <0 |
| Comparative Example 2 | Ba | Zr_{0.96}Ti_{0.04} | 4.0 | 6.0 | Mn, Si, Al | >0 | <0 |
| Comparative Example 3 | Ca_{0.70}Sr_{0.30} | Zr_{0.96}Ti_{0.04} | 4.0 | 4.0 | Si, Al | ≤0 | <0 |
| Comparative Example 4 | Ca_{0.70}Sr_{0.30} | Zr_{0.96}Ti_{0.04} | 0.8 | 4.4 | Mn, Si, Al | >0 | <0 |
| Example 5 | Ca_{0.70}Sr_{0.30} | Zr_{0.96}Ti_{0.04} | 2.0 | 5.4 | Cr, Si, Al | >0 | <0 |
| Comparative Example 5 | Ca_{0.70}Sr_{0.30} | Zr_{0.96}Ti_{0.04} | 6.8 | 7.4 | Cr, Si, Al | >0 | <0 |
| Comparative Example 6 | Ca_{0.70}Sr_{0.30} | Zr_{0.96}Ti_{0.04} | 4.0 | 6.0 | Mn, Si, Al | >0 | <0 |
| Example 6 | Ca_{0.70}Sr_{0.30} | Zr_{0.96}Ti_{0.04} | 4.0 | 6.0 | Mn, Si, Al | >0 | ≥0 |
| Example 7 | Ca_{0.70}Sr_{0.30} | Zr_{0.96}Ti_{0.04} | 4.0 | 6.0 | Mn, Si, Al | >0 | <0 |

| | Specific main | | Main phase grain | | | |
|---|---|---|---|---|---|---|
| | phase grain | | First | | | |
| | | Number | minute | Grain | Characteristics | |
| | Included | ratio | region | size | Temperature | Hot-IR |
| Sample No. | or not | [%] | [%] | [um] | characteristics | [Ω] |
| Example 1 | Included | 67 | 87 | 0.70 | Passed | 5.2E+12 |
| Example 2 | Included | 56 | 82 | 0.65 | Passed | 3.4E+12 |
| Example 3 | Included | 60 | 85 | 0.95 | Passed | 4.2E+12 |
| Example 4 | Included | 73 | 93 | 0.70 | Passed | 3.5E+12 |
| Comparative Example 1 | Included | 54 | 62 | 1.00 | Failed | 7.7E+11 |
| Comparative Example 2 | Included | 38 | 52 | 0.95 | Failed | 3.3E+10 |
| Comparative Example 3 | Not included | 0 | — | 1.35 | Passed | 9.7E+10 |
| Comparative Example 4 | Not included | 0 | 15 | 1.40 | Passed | 3.6E+11 |
| Example 5 | Included | 55 | 76 | 1.00 | Passed | 4.1E+12 |
| Comparative Example 5 | Included | 90 | 96 | 1.30 | Failed | 1.8E+12 |
| Comparative Example 6 | Not included | 0 | 98 | 1.50 | Failed | 2.9E+12 |
| Example 6 | Included | 93 | 96 | 1.40 | Passed | 1.6E+12 |
| Example 7 | Included | 88 | 91 | 0.80 | Passed | 7.1E+12 |

According to Table 1, in a situation where the perovskite compound having a predetermined composition was contained as the main component; the total content of Ti, Mn, and Cr was not too high; and at least some of the main phase grains 14 were the specific main phase grains, both temperature characteristics and insulation resistance were good.

In contrast, in Comparative Example 1, in which Ca was not contained as an A-site element, both temperature characteristics and insulation resistance were insufficient. In Comparative Example 2, in which both Ca and Sr were not contained as A-site elements, temperature characteristics were insufficient, and insulation resistance was significantly low.

In both Comparative Example 3, in which neither Mn nor Cr was contained as an additional element, and Comparative Example 4, in which Mn was contained as an additional element but was little in amount, the specific main phase grains were not included. Comparative Example 3 had significantly low insulation resistance whereas Comparative Example 4 had insufficient insulation resistance.

In Comparative Example 5, in which the total content of Ti, Mn, and Cr was too high, temperature characteristics were insufficient because Cr solid-dissolved in the main phase grains 14 too much.

In Comparative Example 6, in which the holding temperature of the heat treatment prior to preparation of the dielectric paste was 1200° C., the specific main phase grains were not included, and temperature characteristics were insufficient.

### Experiment 2

Example 9 was carried out as in Example 1 except that the total content of Ti, Mn, and Cr was changed. Example 8 was carried out as in Example 9 except that the main-component raw material powder had a specific area ratio of about 3.5 m²/g. Table 2 shows the test results together with those of Examples 1, 6, and 7 of Experiment 1.

TABLE 2

| | | | Dielectric | | | | |
|---|---|---|---|---|---|---|---|
| | | | | | Additional | | |
| | | | | | element in | | |
| | | | α | Ti + Mn + Cr | descending | Mn + Cr − Si | |
| | Perovskite compound | | [parts | [parts | order of | | Grain |
| Sample No. | A site | B site | by mol] | by mol] | content | Dielectric | boundary |
| Example 8 | Ca_{0.70}Sr_{0.30} | Zr_{0.96}Ti_{0.04} | 1.4 | 4.7 | Mn, Si, Al | >0 | <0 |
| Example 9 | Ca_{0.70}Sr_{0.30} | Zr_{0.96}Ti_{0.04} | 2.1 | 4.7 | Mn, Si, Al | >0 | <0 |
| Example 1 | Ca_{0.70}Sr_{0.30} | Zr_{0.96}Ti_{0.04} | 4.0 | 6.0 | Mn, Si, Al | >0 | <0 |
| Example 7 | Ca_{0.70}Sr_{0.30} | Zr_{0.96}Ti_{0.04} | 4.0 | 6.0 | Mn, Si, Al | >0 | <0 |
| Example 6 | Ca_{0.70}Sr_{0.30} | Zr_{0.96}Ti_{0.04} | 4.0 | 6.0 | Mn, Si, Al | >0 | ≥0 |

| | Specific main | | Main phase grain | | | |
|---|---|---|---|---|---|---|
| | phase grain | | First | | | |
| | | Number | minute | Grain | Characteristics | |
| | Included | ratio | region | size | Temperature | Hot-IR |
| Sample No. | or not | [%] | [%] | [um] | characteristics | [Ω] |
| Example 8 | Included | 28 | 43 | 1.25 | Passed | 1.9E+12 |
| Example 9 | Included | 33 | 55 | 0.80 | Passed | 3.2E+12 |
| Example 1 | Included | 67 | 87 | 0.70 | Passed | 5.2E+12 |
| Example 7 | Included | 88 | 91 | 0.80 | Passed | 7.1E+12 |
| Example 6 | Included | 93 | 96 | 1.40 | Passed | 1.6E+12 |

According to Table 2, in a situation where the perovskite compound having the predetermined composition was contained as the main component; the total content of Ti, Mn, and Cr was not too high; and at least some of the main phase grains 14 were the specific main phase grains, both temperature characteristics and insulation resistance were good. Moreover, in a situation where the number ratio of the specific main phase grains was 30% or more and 90% or less, insulation resistance was particularly improved.

### Experiment 3

Example 10 was carried out as in Example 8 except that the main-component raw material powder had a specific surface area of about 20 m²/g. Comparative Example 6 was carried out as in Example 1 except that the holding temperature of the heat treatment for providing the dielectric powder was 1200° C. Example 11 was carried out as in Example 1 except that the total content of Ti, Mn, and Cr was increased from that of Example 1. Table 3 shows the results.

TABLE 3

| | | | Dielectric | | | | |
|---|---|---|---|---|---|---|---|
| | | | | | Additional | | |
| | | | | | element in | | |
| | | | α | Ti + Mn + Cr | descending | Mn + Cr − Si | |
| | Perovskite compound | | [parts | [parts | order of | | Grain |
| Sample No. | A site | B site | by mol] | by mol] | content | Dielectric | boundary |
| Example 8 | Ca_{0.70}Sr_{0.30} | Zr_{0.96}Ti_{0.04} | 1.4 | 4.7 | Mn, Si, Al | >0 | <0 |
| Example 10 | Ca_{0.70}Sr_{0.30} | Zr_{0.96}Ti_{0.04} | 1.4 | 4.7 | Mn, Si, Al | >0 | <0 |
| Example 1 | Ca_{0.70}Sr_{0.30} | Zr_{0.96}Ti_{0.04} | 4.0 | 6.0 | Mn, Si, Al | >0 | <0 |
| Example 11 | Ca_{0.70}Sr_{0.30} | Zr_{0.96}Ti_{0.04} | 4.8 | 6.4 | Mn, Si, Al | >0 | <0 |
| Comparative | Ca_{0.70}Sr_{0.30} | Zr_{0.96}Ti_{0.04} | 4.0 | 6.0 | Mn, Si, Al | >0 | <0 |
| Example 6 | | | | | | | |

| | Specific main | | Main phase grain | | | |
|---|---|---|---|---|---|---|
| | phase grain | | First | | | |
| | | Number | minute | Grain | Characteristics | |
| | Included | ratio | region | size | Temperature | Hot-IR |
| Sample No. | or not | [%] | [%] | [um] | characteristics | [Ω] |
| Example 8 | Included | 28 | 43 | 1.25 | Passed | 1.9E+12 |
| Example 10 | Included | 42 | 54 | 1.00 | Passed | 4.1E+12 |
| Example 1 | Included | 67 | 87 | 0.70 | Passed | 5.2E+12 |
| Example 11 | Included | 70 | 94 | 0.85 | Passed | 6.1E+12 |
| Comparative | Not included | 0 | 98 | 1.50 | Failed | 2.9E+12 |
| Example 6 | | | | | | |

According to Table 3, in a situation where the perovskite compound having the predetermined composition was contained as the main component; the total content of Ti, Mn, and Cr was not too high; and at least some of the main phase grains 14 were the specific main phase grains, both temperature characteristics and insulation resistance were good. In a situation where the area ratio of the first minute regions in a section was 50% or more and 95% or less, insulation resistance was particularly improved.

In contrast, in Comparative Example 6, in which the specific main phase grains were not included and the area ratio of the first minute regions was too high, temperature characteristics were insufficient.

### Experiment 4

Examples 12 and 13 and Comparative Example 7 were carried out as in Example 1 except that the additional elements content was changed. Table 4 shows the results.

TABLE 4

| | | | Dielectric | | | | |
|---|---|---|---|---|---|---|---|
| | | | | | Additional | | |
| | | | | | element in | | |
| | | | α | Ti + Mn + Cr | descending | Mn + Cr − Si | |
| | Perovskite compound | | [parts | [parts | order of | | Grain |
| Sample No. | A site | B site | by mol] | by mol] | content | Dielectric | boundary |
| Example 12 | Ca_{0.70}Sr_{0.30} | Zr_{0.96}Ti_{0.04} | 1.5 | 4.8 | Mn, Si, Al | >0 | ≥0 |
| Example 13 | Ca_{0.70}Sr_{0.30} | Zr_{0.96}Ti_{0.04} | 1.8 | 4.9 | Mn, Si, Al | >0 | <0 |
| Example 1 | Ca_{0.70}Sr_{0.30} | Zr_{0.96}Ti_{0.04} | 4.0 | 6.0 | Mn, Si, Al | >0 | <0 |
| Example 11 | Ca_{0.70}Sr_{0.30} | Zr_{0.96}Ti_{0.04} | 4.8 | 6.4 | Mn, Si, Al | >0 | <0 |
| Comparative | Ca_{0.70}Sr_{0.30} | Zr_{0.96}Ti_{0.04} | 6.4 | 7.2 | Mn, Si, Al | >0 | <0 |
| Example 7 | | | | | | | |
| Example 14 | Ca_{0.70}Sr_{0.30} | Zr_{0.96}Ti_{0.04} | 4.0 | 5.5 | Si, Mn, Al | ≤0 | <0 |
| Example 7 | Ca_{0.70}Sr_{0.30} | Zr_{0.96}Ti_{0.04} | 4.0 | 6.0 | Mn, Si, Al | >0 | <0 |
| Example 15 | Ca_{0.70}Sr_{0.30} | Zr_{0.96}Ti_{0.04} | 4.0 | 5.5 | Al, Mn, Si | >0 | ≥0 |

| | Specific main | | Main phase grain | | | |
|---|---|---|---|---|---|---|
| | phase grain | | First | | | |
| | | Number | minute | Grain | Characteristics | |
| | Included | ratio | region | size | Temperature | Hot-IR |
| Sample No. | or not | [%] | [%] | [um] | characteristics | [Ω] |
| Example 12 | Included | 28 | 57 | 1.30 | Passed | 2.8E+12 |
| Example 13 | Included | 35 | 63 | 1.00 | Passed | 4.0E+12 |
| Example 1 | Included | 67 | 87 | 0.70 | Passed | 5.2E+12 |
| Example 11 | Included | 70 | 94 | 0.85 | Passed | 6.1E+12 |
| Comparative | Included | 83 | 90 | 0.85 | Failed | 8.5E+11 |
| Example 7 | | | | | | |
| Example 14 | Included | 27 | 50 | 1.25 | Passed | 2.7E+12 |
| Example 7 | Included | 88 | 91 | 0.80 | Passed | 7.1E+12 |
| Example 15 | Included | 21 | 43 | 1.35 | Passed | 1.8E+12 |

According to Table 4, in Examples 1 and 11 to 13, in which the perovskite compound having the predetermined composition was contained as the main component; the total content of Ti, Mn, and Cr was not too high; and at least some of the main phase grains 14 were the specific main phase grains, both temperature characteristics and insulation resistance were good. In particular, in a situation where the total content of Mn and Cr of the dielectric ceramic composition was higher than the Si content of the dielectric ceramic composition and the Si content of the grain boundary was higher than the total content of Mn and Cr of the grain boundary, insulation characteristics were particularly good.

In contrast, in Comparative Example 7, in which the total content of Ti, Mn, and Cr was too high, temperature characteristics and insulation characteristics were insufficient.

### Experiment 5

Examples 14 and 15 were examples in which the total additional elements content was the same as that of Example 7 but each element content was changed. Examples 14 and 15 were carried out as in Example 7 except for each element content. The order in amounts of the additional elements was changed. Table 4 shows the results.

According to Table 4, in Examples 14 and 15, in which the perovskite compound having the predetermined composition was contained as the main component; the total content of Ti, Mn, and Cr was not too high; and at least some of the main phase grains 14 were the specific main phase grains, both temperature characteristics and insulation resistance were good as in Example 7. However, in both Example 14, in which the total content of Mn and Cr of the dielectric ceramic composition was not more than the Si content of the dielectric ceramic composition, and Example 15, in which the Si content of the grain boundary was not more than the total content of Mn and Cr of the grain boundary, insulation characteristics were lower than those of Example 7.

### Experiment 6

In Examples 16 to 18, the holding temperature of Example 7 during firing was changed to change the average grain size of the main phase grains 14. Specifically, the holding temperature of Example 7 during firing was reduced by 40° C. in Example 16, was reduced by 20° C. in Example 17, and was increased by 20° C. in Example 18. Table 5 shows the results. Table 5 also shows the test results of Example 6, in which the specific surface area of the main-component raw material powder was changed to change the average grain size of the main phase grains 14.

TABLE 5

| | | | Dielectric | | | | |
|---|---|---|---|---|---|---|---|
| | | | | | Additional | | |
| | | | | | element in | | |
| | | | α | Ti + Mn + Cr | descending | Mn + Cr − Si | |
| | Perovskite compound | | [parts | [parts | order of | | Grain |
| Sample No. | A site | B site | by mol] | by mol] | content | Dielectric | boundary |
| Example 16 | Ca_{0.70}Sr_{0.30} | Zr_{0.96}Ti_{0.04} | 4.0 | 6.0 | Mn, Si, Al | >0 | ≥0 |
| Example 17 | Ca_{0.70}Sr_{0.30} | Zr_{0.96}Ti_{0.04} | 4.0 | 6.0 | Mn, Si, Al | >0 | <0 |
| Example 7 | Ca_{0.70}Sr_{0.30} | Zr_{0.96}Ti_{0.04} | 4.0 | 6.0 | Mn, Si, Al | >0 | <0 |
| Example 18 | Ca_{0.70}Sr_{0.30} | Zr_{0.96}Ti_{0.04} | 4.0 | 6.0 | Mn, Si, Al | >0 | <0 |
| Example 6 | Ca_{0.70}Sr_{0.30} | Zr_{0.96}Ti_{0.04} | 4.0 | 6.0 | Mn, Si, Al | >0 | ≥0 |

| | Specific main | | Main phase grain | | | |
|---|---|---|---|---|---|---|
| | phase grain | | First | | | |
| | | Number | minute | Grain | Characteristics | |
| | Included | ratio | region | size | Temperature | Hot-IR |
| Sample No. | or not | [%] | [%] | [um] | characteristics | [Ω] |
| Example 16 | Included | 25 | 47 | 0.40 | Passed | 2.5E+12 |
| Example 17 | Included | 37 | 66 | 0.50 | Passed | 3.5E+12 |
| Example 7 | Included | 88 | 91 | 0.80 | Passed | 7.1E+12 |
| Example 18 | Included | 86 | 93 | 1.20 | Passed | 5.5E+12 |
| Example 6 | Included | 93 | 96 | 1.40 | Passed | 1.6E+12 |

According to Table 5, in Examples 16 to 18, in which the perovskite compound having the predetermined composition was contained as the main component; the total content of Ti, Mn, and Cr was not too high; and at least some of the main phase grains 14 were the specific main phase grains, both temperature characteristics and insulation resistance were good as in Example 7. Moreover, in each Example in which the average grain size of the main phase grains 14 was 0.50 um or more and 1.20 um or less, insulation characteristics were particularly improved.

### REFERENCE NUMERALS

1 . . . multilayer ceramic capacitor
2 . . . dielectric layer
3 . . . internal electrode layer
4 . . . external electrode
10 . . . element body
14 . . . main phase grain
16 . . . grain boundary

What is claimed is:

1. A dielectric ceramic composition comprising:
main phase grains; and
a grain boundary between the main phase grains,
wherein
the main phase grains comprise a perovskite compound as a main component;
the perovskite compound comprises at least Ca and Sr as A-site elements and at least Zr and Ti as B-site elements;
the dielectric ceramic composition further comprises an oxide of at least one additional element;
the at least one additional element comprises at least one selected from the group consisting of Mn and Cr;
the dielectric ceramic composition has a total content of Ti, Mn, and Cr of 7.0 parts by mol or less with respect to 100 parts by mol B-site elements;
the main phase grains comprise a specific main phase grain;
the specific main phase grain comprises a first minute region and a second minute region;
the first minute region has an atomic ratio of a total content of Mn and Cr to a total content of Ti, Mn, and Cr of 0.2 or more;
the second minute region has an atomic ratio of a total content of Mn and Cr to a total content of Ti, Mn, and Cr of less than 0.2;
the first minute region is located in a peripheral portion of the specific main phase grain and has a thickness of a quarter or more of an equivalent circle radius of the specific main phase grain from the grain boundary to a center of the specific main phase grain; and
the second minute region is located in a central portion of the specific main phase grain.

2. The dielectric ceramic composition according to claim 1, wherein a number ratio of the specific main phase grain to the main phase grains is 30% or more and 90% or less.

3. The dielectric ceramic composition according to claim 1, wherein the first minute region accounts for an area ratio of 50% or more and 95% or less of a section of the dielectric ceramic composition.

4. The dielectric ceramic composition according to claim 1, wherein
the at least one additional element comprises Si, Al, and at least one selected from the group consisting of Mn and Cr;
the dielectric ceramic composition has a total content of the at least one additional element of 1.8 parts by mol or more and 5.0 parts by mol or less with respect to 100 parts by mol B-site elements;
the dielectric ceramic composition has a total content of Mn and Cr exceeding a Si content of the dielectric ceramic composition; and
the grain boundary has a Si content exceeding a total content of Mn and Cr of the grain boundary.

5. The dielectric ceramic composition according to claim 1, wherein the main phase grains have an average grain size of 0.50 um or more and 1.20 um or less.

6. A multilayer ceramic electronic device comprising the dielectric ceramic composition according to claim 1.
